(19) United States
(12) Patent Application Publication
(10) Pub. No.: US 2014/0256532 A1
(43) Pub. Date: Sep. 11, 2014

(54) Oriented Photocatalytic Semiconductor Surfaces

(71) Applicant: Sunpower Technologies LLC, (US)

(72) Inventors: Daniel Landry, Redondo Beach, CA (US); Travis Jennings, San Diego, CA (US)

(73) Assignee: Sunpower Technologies LLC, San Marcos, CA (US)

(21) Appl. No.: 13/788,580

(22) Filed: Mar. 7, 2013

(51) Int. Cl. B01J 35/00

(52) U.S. Cl. CPC B01J 35/004
USPC 502/1

(57) ABSTRACT

The present disclosure relates to oriented photocatalytic semiconductor surfaces which may include photocatalytic capped colloidal nanocrystals (PCCNs) positioned all in the same orientation. The photoactive material may be employed in a plurality of photocatalytic energy conversion applications such as the photocatalytic reduction of carbon dioxide and water splitting, among others. The disclosed oriented PCCNs, within the oriented photoactive material, may also exhibit different shapes and sizes, and higher efficiency in a light harvesting process. Having all the PCCNs oriented at the same angle and dipole moment may allow the light to interact with the dipole at an increased efficiency, to predict the polarity of the light or a more efficient interaction with the nanocrystals substrate, and therefore, increasing the harvesting efficiency by controlling different parts of the light spectrum in the same system.

### CROSS-REFERENCE TO RELATED APPLICATIONS

The disclosure here described is related to the invention disclosed in the U.S. application No. (not yet assigned), entitled “Photocatalyst for the Production of Hydrogen” and U.S. application No. (not yet assigned), entitled “Photocatalyst for the Reduction of Carbon Dioxide,” which are hereby incorporated by reference in their entirety.

### BACKGROUND

1. Technical Field

The present disclosure relates to photoactive materials employed in energy conversion applications. In particular, the present disclosure relates to compositions and methods to form oriented photocatalytic semiconductor surfaces.

2. Background Information

Nanometer-scaled composites provide the opportunity to combine useful attributes of two or more materials within a single composite or to generate entirely new properties as a result of the intermixing of two or more materials. Semiconductor nanocrystals also provide an improved degree of electronic and structural flexibility, primarily exemplified by the ability to continuously tailor the size of the particles and therefore, via quantum confinement effects, the electronic properties of the particles. An appropriately-tailored inorganic nanocomposite may provide outstanding thermoelectric characteristics. Inorganic nanocomposites may also exhibit high tunability.

Effectiveness of nanostructured materials is determined to a great extent by the semiconductor's capability of absorbing visible and infrared light, in addition to the requirement of a large surface area that may facilitate more efficient carrier dynamics. Additionally, switching from bulk materials to nanostructures introduces new challenges, such as the increased role of interfaces. Previous research mostly has focused on optimization of the nano-components in nanoscale semiconductors as less attention has been directed towards the efficiency of electronic transport within or between individual nanostructures, but current methods include random oriented structures that don't take full advantage of the spectrum range of light.

There is still a need for improvement in this field, including the need for development of improved materials and devices that may operate with higher energy conversion efficiency for alternative fuel generation. A solar energy based technology may partly fulfill energy demands within the existing hydrocarbon based fuel economy.

It is an object of the present disclosure to provide embodiments for the composition and fabrication of photoactive materials that may exhibit high energy conversion efficiency.

### SUMMARY

Aspects of the current disclosure are oriented photocatalytic semiconductor surfaces which may be employed as photoactive material in energy conversion applications. The orientation of the photocatalytic nanocrystals in the photoactive material may allow controlling different parts of the light spectrum in the same system increasing the efficiency in the energy conversion process. This homogeneous orientation of the nanocrystals upon a substrate may be achieved employing a variety of state of the art methods, such as template-driven seeded growth, electric fields application, or other appropriate orientational forces.

The oriented photocatalytic semiconductor surfaces may include semiconductor nanocrystals capped with inorganic capping agents in order to form a photocatalytic capped colloidal nanocrystal (PCCN) composition that may be deposited on a substrate and treated to produce a solid matrix of oriented photoactive material. The oriented photoactive material may be employed to increase the efficiency of harvesting light to convert the energy for various applications, such as water splitting and carbon dioxide reduction into methane and water for the production of hydrogen and oxygen.

The method for producing PCCN may include semiconductor nanocrystals synthesis and substituting organic capping agents with inorganic capping agents. In accordance to an embodiment, the PCCN (e.g. noble metals, nickel, copper, titanium dioxide, zinc sulfide and mixtures thereof) composition may be deposited on a substrate and thermally treated, by a variety of known in the art techniques, to anneal and form inorganic matrices with embedded PCCN.

An effect of employing the methods of fabrication and deposition of the present disclosure may be the cost efficiency achieved due to low temperature requirements during semiconductor nanocrystals synthesis and inorganic capping of semiconductor nanocrystals, and simple/low cost methods of deposition, additionally, energy conversion efficiency can be improved compared to state of the art techniques, because of the homogeneous direction of the dipole moment and the ability increase the harvesting light efficiency.

According to various embodiments, the disclosed PCCNs in the photoactive material may include different configurations, such as spherical, tetrapod, core/shell, graphene, carbon nanotubes, nanorods, nanowires, nanosprings and nanodendritic, among others. Varying the configuration of PCCNs may be achieved by changing the reaction time, reaction temperature profile, or structure of organic capping agents to passivate the surface of semiconductor nanocrystals during growth.

Materials of the semiconductor nanocrystals within the PCCNs may be selected in accordance with the irradiation wavelength. Changing the materials and shapes of semiconductor nanocrystals may enable tuning of the band-gap and band-offsets to expand the range of wavelengths usable by the photoactive material, and therefore, the application, e.g. water splitting. Absorbance wavelengths and enhancement of carrier dynamics may also be increased due to high surface areas of the semiconductor nanocrystals.

Numerous other aspects, features of the present disclosure may be made apparent from the following detailed description, taken together with the drawing figures.

In one embodiment, a method for forming an oriented photoactive material comprises: growing semiconductor nanocrystals; capping the semiconductor nanocrystals with an inorganic capping agent in a polar solvent to form photocatalytic capped colloidal nanocrystals; depositing the photocatalytic capped colloidal nanocrystals onto a substrate; orienting the photocatalytic capped colloidal nanocrystals; and thermally treating the oriented photocatalytic capped colloidal nanocrystals.

In another embodiment, a photoactive material comprises: a substrate; and homogenously oriented photocatalytic capped colloidal nanocrystals deposited on the substrate, wherein the photocatalytic capped colloidal nanocrystals are oriented by applying an orientational force to the photocatalytic capped colloidal nanocrystals, and the orientation depends on a desired wavelength of visible or infrared light to be absorbed by the photocatalytic capped colloidal nanocrystals.

Additional features and advantages of an embodiment will be set forth in the description which follows, and in part will be apparent from the description. The objectives and other advantages of the invention will be realized and attained by the structure particularly pointed out in the exemplary embodiments in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The present disclosure can be better understood by referring to the following figures. The components in the figures are not necessarily to scale, emphasis instead being placed upon illustrating the principles of the invention. In the figures, reference numerals designate corresponding parts throughout the different views.

FIG. 1 is a flowchart of a method for forming a composition of PCCNs, according to an embodiment.

FIG. 2 shows an embodiment of nanorod configuration of PCCNs.

FIG. 3 illustrates the principle of the transition dipole moment within PCCN, according to an embodiment

FIG. 4 is a flowchart of a method for forming oriented photocatalyst semiconductor surfaces, according to an embodiment.

FIG. 5 depicts an alignment process employing electric fields, according to an embodiment.

FIG. 6 depicts an embodiment oriented PCCNs in nanorod configuration showing oriented dipole moment receiving light.

FIG. 7 illustrates an embodiment of oriented PCCNs in nanorod configuration upon substrate, forming oriented photoactive material employed in the present disclosure.

### DETAILED DESCRIPTION

Reference will now be made in detail to the preferred embodiments, examples of which are illustrated in the accompanying drawings. The embodiments described above are intended to be exemplary. One skilled in the art recognizes that numerous alternative components and embodiments that may be substituted for the particular examples described herein and still fall within the scope of the invention.

Oriented photocatalyst semiconductor surfaces are disclosed. Disclosed oriented photocatalytic semiconductor surfaces may be used as a photoactive material which, according to an embodiment, may be employed for a high efficiency harvesting light.

In the following detailed description, reference is made to the accompanying drawings, which form a part hereof. In the drawings, which are not to scale or to proportion, similar symbols typically identify similar components, unless context dictates otherwise. The illustrative embodiments described in the detailed description, drawings and claims, are not meant to be limiting. Other embodiments may be used and/or and other changes may be made without departing from the spirit or scope of the present disclosure.

### DEFINITIONS

As used here, the following terms may have the following definitions:

“Semiconductor nanocrystals” refers to particles sized between about 1 and about 100 nanometers produced using semiconducting materials with high surface areas able to absorb light.

“Branched” refers to segments grown onto a semiconductor nanocrystal face or branch in a nonlinear alignment with the semiconductor nanocrystal face or branch.

“Dendritic” refers to tree-shaped or branched-shaped photocatalytic capped colloidal nanocrystals.

“Electric dipole moment” refers to the separation of positive and negative charge on a system.

“Electron-hole pairs” refers to charge carriers that are created when an electron acquires energy sufficient to move from a valence band to a conduction band and creates a free hole in the valence band, thus starting a process of charge separation.

“Inorganic capping agent” refers to semiconductor particles that cap semiconductor nanocrystals.

“Heteroaggregate” refers to a combination of at least two elements chemically bonded but not alloyed with each other.

“Nanocrystal growth” refers to a synthetic process including the reaction of component precursors of a semiconductor nanocrystal in the presence of a stabilizing organic ligand.

“Orientation” refers to the rotation needed to bring a nanocrystal into position or alignment so that its longitudinal axis has a desired angle.

“Photoactive material” refers to a substance that may be used in photocatalytic processes for absorbing light and starting a chemical reaction with light.

“Polarization” refers to a process in which waves of light are restricted to certain directions of vibration.

“Transition dipole moment” refers to the axis of a system that may interact with light of a certain polarization.

### DESCRIPTION OF DRAWINGS

Method for Growing Oriented Semiconductor Nanocrystals

Controlling the orientation of the semiconductor nanocrystals in a substrate may allow controlling different parts of the light spectrum in the same system, therefore, increasing the efficiency in the light harvesting process. A homogeneous orientation of the nanocrystals upon a substrate may be achieved employing a variety of state of the art methods, such as template-driven seeded growth, electric fields application, or other appropriate orientational forces. The orientation of the nanocrystals may be along either 1 crystallographic axis (1D orientation), or orientation along 2 axes (2D orientation). Once orientation is fixed along 2 axes, the 3rd axis may be already fixed for a rigid structure.

In an embodiment, semiconductor nanocrystals may be grown employing a known in the art method for template-driven seeded growth. Seeded growth refers to methods for growing crystals in which a seed crystal may be used to initiate crystal lattice growth and elongation (as opposed to forcing a nucleation event before crystal growth may be observed). In an embodiment, the seed crystal may be freely dispersed in a solution, or may be deposited on a substrate. In another embodiment, the seed crystal may be the substrate itself, or may be composed of the same material as the intended semiconductor nanocrystal. In another embodiment, the seed crystal may be composed of another crystalline material with the proper crystal lattice structure, atomic spacing, and surface energy to promote further crystal growth. For example, GaSb has shown to be an appropriate surface for semiconductor growth. In this scenario, a GaSb single nanocrystal surface could be used to seed the growth of a semiconductor nanocrystal using molecular beam epitaxy (MBE), or chemical beam epitaxy (CBE) so that nanocrystal growth is templated by the substrate crystal structure. Photocatalyst layers would then be grown on top of the aligned and oriented semiconductor nanocrystal.

The seeded growth method may have the benefit of lowering the activation energy required for crystal growth to occur, as well as other reaction parameters, such as monomer concentration and reaction temperature, and allowing a degree of control over deposition density, growth rate, and orientation dispersion to yield a highly uniform and oriented nanocrystal surface with 2D/3D orientation.

The morphologies of semiconductor nanocrystals may include nanorods, nanoplates, nanowires, dumbbell-like nanoparticles, and dendritic nanomaterials, among others. Each morphology may include an additional variety of shapes such as spheres, cubes, tetrahedra (tetrapods), among others.

To modify optical properties as well as to enhance charge carriers mobility, semiconductor nanocrystals may be capped by inorganic capping agents in polar solvents instead of organic capping agents. In those embodiments, inorganic capping agents may act as photocatalysts to facilitate a photocatalytic reaction on the surface of semiconductor nanocrystals. Optionally, semiconductor nanocrystals may be modified by the addition of not one but two different inorganic capping agents. In that instance, a reduction inorganic capping agent is first employed to facilitate the reduction half-cell reaction; then, an oxidation inorganic capping agent facilitates the oxidation half-cell reaction. Inorganic capping agents may be neutral or ionic, or they may be discrete species, either linear or branched chains, or two-dimensional sheets. Ionic inorganic capping agents are commonly referred to as salts, pairing a cation and an anion. The portion of the salt specifically referred to as an inorganic capping agent is the ion that displaces the organic capping agent.

Method for Forming Composition of Photocatalytic Capped Colloidal Nanocrystal (PCCN)

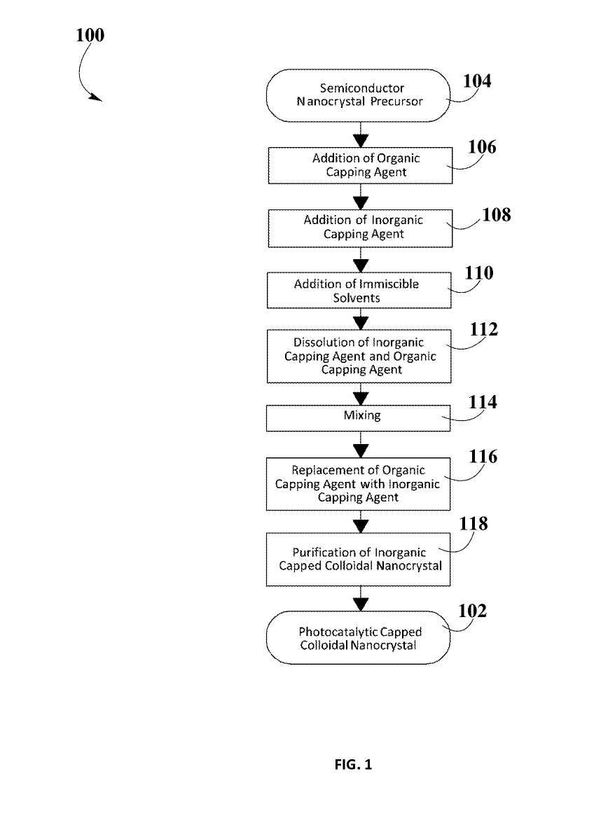

FIG. 1 shows a flow diagram of a method 100 for forming a composition of PCCN 102, according to an embodiment. PCCN 102 may be synthesized following accepted protocols, and may include one or more semiconductor nanocrystals and one or more inorganic capping agents.

Method 100 for forming a composition of PCCN 102 may include a first step where semiconductor nanocrystals may be grown by reacting as semiconductor nanocrystal 104 precursors in the presence of an organic solvent, here referred to as organic capping agent, by the addition of the organic capping agent 106. Additionally, the long organic chains radiating from organic capping agents on the surface of semiconductor nanocrystal 104 precursors may assist in the suspension and/or solubility of semiconductor nanocrystal 104 precursors in a solvent. The chemistry of capping agents may control several system parameters, for example, the size of semiconductor nanocrystal 104 precursors, growth rate or shape, the dispersability in various solvents and solids, and even the excited state lifetimes of charge carriers in semiconductor nanocrystal 104 precursors. The flexibility of synthesis is demonstrated by the fact that often one capping agent may be chosen for its growth control properties, and then later a different capping agent may be substituted to provide a more suitable interface or to modify optical properties or charge carrier mobility.

For the substitution of organic capping agents with inorganic capping agents, organic capped semiconductor nanocrystals in the form of a powder, suspension, or a colloidal solution, may be mixed by the addition of inorganic capping agents 108, causing a reaction of organic capped semiconductor nanocrystals with inorganic capping agents. This reaction rapidly produces insoluble and intractable materials. Afterwards, an addition of immiscible solvents 110 may be made causing the dissolution of organic capping agents and inorganic capping agents 112. These two solutions may then be mixed 114, by combining and stirring them for about 10 minutes, after which a complete transfer of organic capped semiconductor nanocrystals from the non-polar solvent to the polar solvent may be observed. During this exchange, organic capping agents are released. Generally, inorganic capping agents may be dissolved in a polar solvent, while organic capped semiconductor nanocrystals may be dissolved in an immiscible, generally non-polar, solvent. The addition of immiscible solvents 110 may be made to control the reaction, facilitating a rapid and complete replacement of organic capping agents with inorganic capping agents 116

Organic capped semiconductor nanocrystals may react with inorganic capping agents at or near the solvent boundary, where a portion of the organic capping agent may be exchanged/replaced with a portion of the inorganic capping agent. Thus, inorganic capping agents may displace organic capping agents from the surface of semiconductor nanocrystal 104 precursors, and inorganic capping agents may bind to that. This process continues until equilibrium is established between inorganic capping agents and the free inorganic capping agents. Preferably, the equilibrium favors inorganic capping agents. All the steps described above may be carried out in a nitrogen environment inside a glove box.

Subsequently, an isolation procedure, such as the precipitation of inorganic product, may be required for the purification of inorganic capped semiconductor nanocrystals 118 to form a PCCN 102. That precipitation permits one of ordinary skill to wash impurities and/or unreacted materials out of the precipitate. Such isolation may allow for the selective application of PCCN 102.

Neither the morphology nor the size of semiconductor nanocrystal 104 precursors inhibits a method 100 for forming composition of PCCN 102 using the semiconductor nanocrystal 104 precursors; rather, the selection of morphology and size of semiconductor nanocrystal 104 precursors may permit the tuning and control of the properties of PCCN 102.

Examples of semiconductor nanocrystal 104 precursors may include the following: Ag, Au, Ru, Rh, Pt, Pd, Os, Ir, Ni, Cu, CdS, Pt-tipped, TiO₂, Mn/ZnO, ZnO, CdSe, SiO₂, ZrO₂, SnO₂, WO₃, MoO₃, CeO₂, ZnS, WS₂, MoS₂, SiC, GaP, Cu—Au, Ag, and mixtures thereof; Cu/TiO2, Ag/TiO₂, Cu—Fe/TiO₂—SiO₂ and dye-sensitized Cu—Fe/P25 coated optical fibers, AlN, AlP, AlAs, Bi, Bi₂S₃, Bi₂Se₃, Bi₂Te₃, CdS, CdSe, CdTe, Co, CoPt, CoPt₃, Cu₂S, Cu₂Se, CuInSe₂, CuIn₍₁₋ₓ₎Gaₓ(S,Se)₂, Cu₂ZnSn(S,Se)₄, Fe, FeO, Fe₂O₃, Fe₃O₄, FePt, GaN, GaP, GaAs, GaSb, GaSe, Ge, HgS, HgSe, HgTe, InN, InP, InSb, InAs, Ni, PbS, PbSe, PbTe, Si, Sn, ZnSe, ZnTe, and mixtures thereof. Examples of applicable semiconductor nanocrystals may include core/shell semiconductor nanocrystals like Au/PbS, Au/PbSe, Au/PbTe, Ag/PbS, Ag/PbSe, Ag/PbTe, Pt/PbS, Pt/PbSe, Pt/PbTe, Au/CdS, Au/CdSe, Au/CdTe, Ag/CdS, Ag/CdSe, Ag/CdTe, Pt/CdS, Pt/CdSe, Pt/CdTe, Au/FeO, Au/Fe₂O₃, Au/Fe₃O4, Pt/FeO, Pt/Fe₂O₃, Pt/Fe₃O₄, FePt/PbS, FePt/PbSe, FePt/PbTe, FePt/CdS, FePt/CdSe, FePt/CdTe, CdSe/CdS, CdSe/ZnS, InP/CdSe, InP/ZnS, InP/ZnSe, InAs/CdSe, and InAs/ZnSe; nanorods like CdSe, core/shell nanorods like CdSe/CdS; nano-tetrapods like CdTe, and core/shell nano-tetrapods like CdSe/CdS.

The organic solvent may be a stabilizing organic ligand. One example of an organic capping agent may be trioctylphosphine oxide (TOPO). TOPO 99% may be obtained from Sigma-Aldrich Co. LLC (St. Louis, Mo.). TOPO capping agent prevents the agglomeration of semiconductor nanocrystals during and after their synthesis. Other suitable organic capping agents may include long-chain aliphatic amines, long-chain aliphatic phosphines, long-chain aliphatic carboxylic acids, long-chain aliphatic phosphonic acids and mixtures thereof.

Some examples of polar solvents may include 1,3-butanediol, acetonitrile, ammonia, benzonitrile, butanol, dimethylacetamide, dimethylamine, dimethylethylenediamine, dimethylformamide, dimethylsulfoxide (DMSO), dioxane, ethanol, ethanolamine, ethylenediamine, ethyleneglycol, formamide (FA), glycerol, methanol, methoxyethanol, methylamine, methylformamide, methylpyrrolidinone, pyridine, tetramethylethylenediamine, triethylamine, trimethylamine, trimethylethylenediamine, water, and mixtures thereof. Polar solvents like FA, spectroscopy grade, and DMSO, anhydrous, 99.9% may be supplied by Sigma-Aldrich Co. LLC. Suitable colloidal stability of the dispersions of semiconductor nanocrystal 104 precursors is mainly determined by a solvent dielectric constant, which may range between about 106 to about 47, with about 106 being preferred.

Examples of non-polar or organic solvents may include tertiary-Butanol, pentane, pentanes, cyclopentane, hexane, hexanes, cyclohexane, heptane, octane, isooctane, nonane, decane, dodecane, hexadecane, benzene, 2,2,4-trimethylpentane, toluene, petroleum ether, ethyl acetate, diisopropyl ether, diethyl ether, carbon tetrachloride, carbon disulfide, and mixtures thereof. Other examples may include alcohol, hexadecylamine (HDA), hydrocarbon solvents at high temperatures.

Preferred inorganic capping agents for PCCN 102 may include chalcogenides, and zintl ions (homopolyatomic anions and heteropolyatomic anions that may have intermetallic bonds between the same or different metals of the main group, transition metals, lanthanides, and/or actinides, for example, As₃³⁻, As₄²⁻, As₅³⁻, As₇³⁻, Ae₁₁³⁻, AsS₃³⁻, As₂Se₆³⁻, As₂Te₆³⁻, As₁₀Te₃²⁻, Au₂Te₄²⁻, Au₃Te₄³⁻, Bi₃³⁻, Bi₄²⁻, Bi₅³⁻, GaTe²⁻, Ge₉²⁻, Ge₉⁴⁻, Ge₂S₆⁴⁻, HgSe₂²⁻, Hg₃Se₄²⁻, In₂Se₄²⁻, In₂Te₄²⁻, Ni₅Sb₁₇⁴⁻, Pb₅²⁻, Pb₇⁴⁻, Pb₉⁴⁻, Pb₂Sb₂²⁻, Sb₃³⁻, Sb₄²⁻, Sb₇³⁻, SbSe₄³⁻, SbSe₄⁵⁻, SbTe₄⁵⁻, Sb₂Se₃⁻, Sb₂Te₅⁴⁻, Sb₂Te₇⁴⁻, Sb₄Te₄⁴⁻, Sb₉Te₆³⁻, Se₂²⁻, Se₃²⁻, Se₄²⁻, Se_{5,6}²⁻, Se₆²⁻, Sn₅²⁻, Sn₉³⁻, Sn₉⁴⁻, SnS₄⁴⁻, SnSe₄⁴⁻, SnTe₄⁴⁻, SnS₄Mn₂⁵⁻, SnS₂S₆⁴⁻, Sn₂Se₆⁴⁻, Sn₂Te₆⁴⁻, Sn₂Bi₂²⁻, Sn₈Sb³⁻, Te₂²⁻, Te₃²⁻, Te₄²⁻, Tl₂²⁻, TlSn₈³⁻, TlSn₈⁵⁻, TlSn₉³⁻, TlTe₂²⁻, mixed metal SnS₄Mn₂⁵⁻, and the like), where zintl ions refers to homopolyatomic anions and heteropolyatomic anions that have intermetallic bonds between the same or different metals of the main group, lanthanides, and/or actinides, transition metal chalcogenides, such as, tetrasulfides and tetraselenides of vanadium, niobium, tantalum, molybdenum, tungsten, and rhenium, and the tetratellurides of niobium, tantalum, and tungsten. These transition metal chalcogenides may further include the monometallic and polymetallic polysulfides, polyselenides, and mixtures thereof, e.g., MoS(Se₄)₂²⁻, Mo₂S₆²⁻, and the like, polyoxometalates and oxometalates, such as tungsten oxide, iron oxide, zinc oxide, cadmium oxide, zinc sulfide, gallium zinc nitride oxide, bismuth vanadium oxide, zinc oxide, and titanium dioxide, among others; metals selected from transition metals; positively charged counter ions, such as alkali metal ions, ammonium, hydrazinium, tetraalkylammmonium, and the like.

Further embodiments may include other inorganic capping agents. For example, inorganic capping agents may include molecular compounds derived from CuInSe₂, CuInₓGa₁₋ₓSe₂, Ga₂Se₃, In₂Se₃, In₂Te₃, Sb₂S₃, Sb₂Se₃, Sb₂Te₃, and ZnTe.

Method 100 may be adapted to produce a wide variety of PCCN 102. Adaptations of method 100 may include adding two different inorganic capping agents to a single semiconductor nanocrystal 104 precursor, adding two different semiconductor nanocrystal 104 precursors to a single inorganic capping agent, adding two different semiconductor nanocrystal 104 precursors to two different inorganic capping agents, and/or additional multiplicities. The sequential addition of inorganic capping agents 108 to semiconductor nanocrystal 104 precursors may be possible under the disclosed method 100. Depending, for example, upon concentration, nucleophilicity, bond strength between capping agents and semiconductor nanocrystal 104 precursor, and bond strength between semiconductor nanocrystal 104 precursor face dependent capping agent and semiconductor nanocrystal 104 precursor, inorganic capping of semiconductor nanocrystal 104 precursor may be manipulated to yield other combinations.

Suitable PCCNs 102 may include ZnS.TiO₂, TiO₂.CuO, ZnS.RuOₓ, ZnS.ReOₓ, Au.AsS₃, Au.Sn₂S₆, Au.SnS₄, Au.Sn₂Se₆, Au.In₂Se₄, Bi₂S₃.Sb₂Te₅, Bi₂S₃.Sb₂Te₇, Bi₂Se₃.Sb₂Te₅, Bi₂Se₃.Sb₂Te₇, CdSe.Sn₂S₆, CdSe.Sn₂Te₆, CdSe.In₂Se₄, CdSe.Ge₂S₆, CdSe.Ge₂Se₃, CdSe.HgSe₂, CdSe.ZnTe, CdSe.Sb₂S₃, CdSe.SbSe₄, CdSe.Sb₂Te₇, CdSe.In₂Te₃, CdTe.Sn₂S₆, CdTe.Sn₂Te₆, CdTe.In₂Se₄, Au/PbS.Sn₂S₆, Au/PbSe.Sn₂S₆, Au/PbTe.Sn₂S₆, Au/CdS.Sn₂S₆, Au/CdSe.Sn₂S₆, Au/CdTe.Sn₂S₆, FePt/PbS.Sn₂S₆, FePt/PbSe.Sn₂S₆, FePt/PbTe.Sn₂S₆, FePt/CdS.Sn₂S₆, FePt/CdSe.Sn₂S₆, FePt/CdTe.Sn₂S₆, Au/PbS.SnS₄, Au/PbSe.SnS₄, Au/PbTe.SnS₄, Au/CdS.SnS₄, Au/CdSe.SnS₄, Au/CdTe.SnS₄, FePt/PbS.SnS₄FePt/PbSe.SnS₄, FePt/PbTe.SnS₄, FePt/CdS.SnS₄, FePt/CdSe.SnS₄, FePt/CdTe.SnS₄, Au/PbS.In₂Se₄Au/PbSe.In₂Se₄, Au/PbTe.In₂Se₄, Au/CdS.In₂Se₄, Au/CdSe.In₂Se₄, Au/CdTe.In₂Se₄, FePt/PbS.In₂Se₄FePt/PbSe.In₂Se₄, FePt/PbTe.In₂Se₄, FePt/CdS.In₂Se₄, FePt/CdSe.In₂Se₄, FePt/CdTe.In₂Se₄, CdSe/CdS.Sn₂S₆, CdSe/CdS.SnS₄, CdSe/ZnS.SnS₄, CdSe/CdS.Ge₂S₆, CdSe/CdS.In₂Se₄, CdSe/ZnS.In₂Se₄, Cu.In₂Se₄, Cu₂Se.Sn₂S₆, Pd.AsS₃, PbS.SnS₄, PbS.Sn₂S₆, PbS.Sn₂Se₆, PbS.In₂Se₄, PbS.Sn₂Te₆, PbS.AsS₃, ZnSe.Sn₂S₆, ZnSe.SnS₄, ZnS.Sn₂S₆, and ZnS.SnS₄ among others.

As used here the denotation ZnS.TiO₂ may refer to ZnS semiconductor nanocrystal capped with TiO₂ inorganic capping agent. Charges on inorganic capping agent are omitted for clarity. This nomenclature [semiconductor nanocrystal].[inorganic capping agent] is used throughout this description. The specific percentages of semiconductor nanocrystal 104 precursors and inorganic capping agent may vary between different types of PCCN 102.

Structures of PCCN

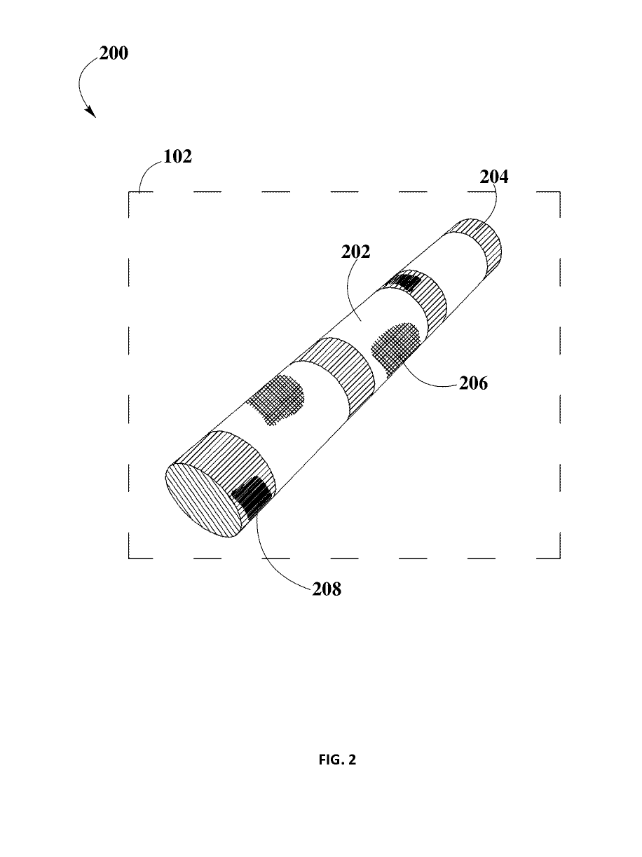

FIG. 2 shows an embodiment of nanorod configuration 200 of PCCN 102 including first semiconductor nanocrystal 202 and second semiconductor nanocrystal 204 capped with first inorganic capping agent 206 and second inorganic capping agent 208, respectively. As an example, PCCN 102 in nanorod configuration 200 may include three ZnS region and four Cu regions as first semiconductor nanocrystal 202 and second semiconductor nanocrystal 204, respectively, where first semiconductor nanocrystal 202 may be larger than each of the four second semiconductor nanocrystal 204 of nanorod configuration 200. In other embodiments, the different regions with different materials may have the same lengths, and there can be any suitable number of different regions. The number of regions per nanorod superlattice in nanorod configuration 200 may vary according to the length of the nanorod. First inorganic capping agent 206 may include ReO₂, while W₂O₃ may be employed as second inorganic capping agent 208.

Other suitable configurations for PCCN 102 may be carbon nanotube, nanowire, nanospring, nanodendritic, spherical, tetrapod, core/shell and graphene configuration. Nanodendritic configuration of PCCN 102, may include a highly conductive heteroaggregate dendritic PCCN 102, e.g., Au/ZnO, Cu/ZnS. For graphene configuration, graphene oxide (GO) may be used as second semiconductor nanocrystal 204. Spherical configuration may include a single semiconductor nanocrystal 104 of ZnS or PbS quantum dots, with TiO₂ or SnTe₄⁴ as first inorganic capping agent 206 and ReO₂ or AsS₃³⁻ as second inorganic capping agent 208. Tetrapod configuration may include a first semiconductor nanocrystal 202, for example ZnS or CdSe, capped with, for example, TiO₂ or Sn₂S₆⁴⁻ as first inorganic capping agent 206, while second semiconductor nanocrystal 204 may be for example, Cu or CdS, capped with TiO₂ or In₂Se₄²⁻ as second inorganic capping agent 208. Core/shell configuration of PCCN 102 may include a first semiconductor nanocrystal 202, which may be, for example, ZnS or CdSe, a second semiconductor nanocrystal 204, which may be, for example, Cu or CdS, a first inorganic capping agent 206, which may be, for example TiO₂ or Sn₂Se₆⁴⁻, and a second semiconductor nanocrystal 204, which may be, for example, TiO2 or Sn₂Se₆⁴⁻. Carbon nanotube configuration may include a carbon nanotube as first semiconductor nanocrystal 202, and graphene foliates as second semiconductor nanocrystal 204; ZnS may be first inorganic capping agent 206 and TiO₂ second inorganic capping agent 208, respectively. Nanowire configuration may include ZnS as semiconductor nanocrystal 104, TiO₂ as first inorganic capping agent 206 and ReO₂ as second inorganic capping agent 208. Nanospring configuration may include ZnS as semiconductor nanocrystal 104, TiO₂ as first inorganic capping agent 206 and W₂O₃ as second inorganic capping agent 208.

Alignment Process for Forming Oriented Photoactive Material

When a PCCN 102 interacts with an electromagnetic wave of frequency, i.e. when a PCCN 102 is being hit by photons, it can undergo a transition from an initial to a final state of energy difference through the coupling of the electromagnetic field to the transition dipole moment (TDM). The process of single photon absorption is characterized by the TDM. The TDM is a vector and has to do with the differences in electric charge distribution between an initial and final state of a PCCN 102. When this transition is from a lower energy state to a higher energy state, this results in the absorption of a photon. A transition from a higher energy state to a lower energy state, results in the emission of a photon.

The TDM may describe in which direction the electric charge within a PCCN 102 shifts during absorption of a photon. The amplitude of TDM is the transition moment between the initial (i) and final (f) states, and may be calculated as <f|V|i>, where “f” may be the wavefunction of the final state of PCCN 102, “i” may be the wavefunction of the initial state of PCCN 102, “V” may be the disturbance or transition dipole moment=mu*E (where “mu” may be the dipole moment of PCCN 102 in initial state, and “E” may be the electric part of the electromagnetic field). V is the electric dipole moment operator, a vector operator that is the sum of the position vectors of all charged particles weighted with their charge.

The TDM direction in the molecular framework defines the direction of transition polarization, and its square determines the strength of the transition.

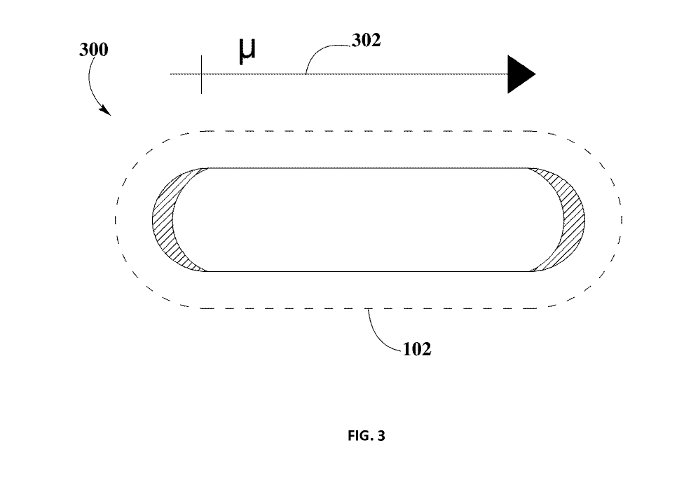

FIG. 3 illustrates dipole moment characterization 300 within PCCN 102, according to an embodiment, describing the axis of the nanocrystal along which the electrons interact with the electromagnetic field of an incident photon. The TDM 302 relates the interaction of PCCN 102 to the polarization of incident light.

TDM 302 is a vector in the molecular framework, characterized both by its direction and its probability. The absorption probability for linearly polarized light is proportional to the cosine square of the angle between the electric vector of the electromagnetic wave and TDM 302; light absorption may be maximized if they are parallel, and no absorption may occur if they are perpendicular.

Therefore, by controlling the orientation of PCCNs 102 employed in a light harvesting system, an increase in the efficiency of light absorption and hence, an increase in the energy conversion may be achieved. For this purpose oriented photoactive materials may be formed applying orientational forces to PCCN 102 during deposition and/or after they are deposited onto a suitable substrate.

Alignment Methods

In an embodiment, semiconductor nanocrystals 104 may be deposited and thermally treated on a suitable substrate, employing known in the art suitable methods (e.g. spraying deposition and annealing methods). For these methods, suitable substrates may include non-porous substrates and porous substrates, which may additionally be optically transparent in order to allow PCCN to receive more light. Suitable non-porous substrates may include polydiallyldimethylammonium chloride (PDDA), polyethylene terephthalate (PET), and silicon, while suitable porous substrates may include TiO₂, glass frits, fiberglass cloth, porous alumina, and porous silicon. Suitable porous substrates may additionally exhibit a pore size sufficient for a gas to pass through at a constant flow rate. Suitable substrates may be planar or parabolic, individually controlled planar plates, or a grid work of plates.

According to an embodiment, semiconductor nanocrystals 104 may be applied to the substrate by means of a spraying device during a period of time depending on preferred thickness of semiconductor nanocrystal 104 composition applied on the substrate.

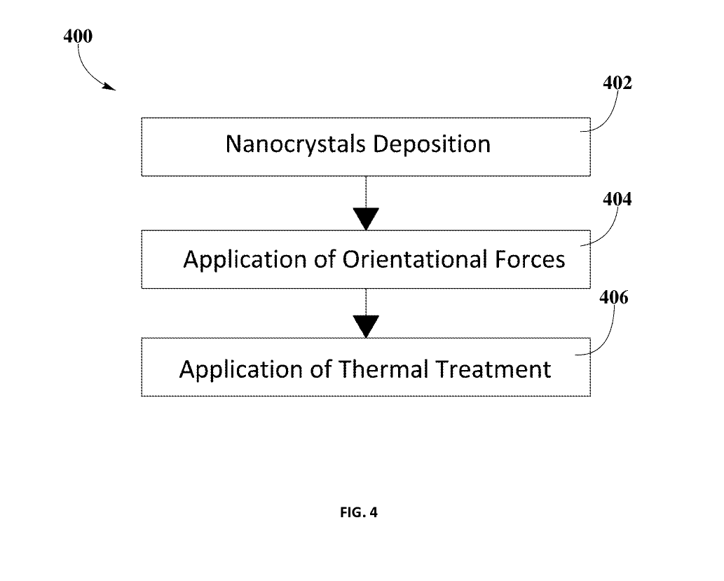

FIG. 4 is a flowchart of alignment method 400 for forming oriented photocatalyst semiconductor surfaces, according to an embodiment. Alignment method 400 for forming oriented photocatalyst semiconductor surfaces may include a deposition 402 of PCCN 102 on a suitable substrate, such as substrates mentioned in FIG. 3.

According to an embodiment, PCCN 102 may be deposited on the substrate by means of a spraying device during a period of time depending on preferred thickness of PCCN 102 composition deposited on the substrate. As a result of the spraying deposition, a photoactive material may be formed.

Other deposition 402 methods of PCCN 102 may include plating, chemical synthesis in solution, chemical vapor deposition (CVD), spin coating, plasma enhanced chemical vapor deposition (PECVD), laser ablation, thermal evaporation, molecular beam epitaxy, electron beam evaporation, pulsed laser deposition (PLD), sputtering, reactive sputtering, atomic layer deposition, sputter deposition, reverse Lang-muir-Blodgett technique, electrostatic deposition, spin coating, inkjet deposition, laser printing (matrices), and the like.

Subsequently, PCCNs 102 within the photoactive material may be oriented by the application of orientational forces 404. Afterwards, PCCN 102 may pass through a thermal treatment 406 employing a convection heater, with temperatures less than between about 200 to about 350° C., to produce crystalline films from the PCCN 102. A thermal treatment 406 may yield, for example, ordered arrays of PCCN 102 within an inorganic matrix, hetero-alloys, or alloys.

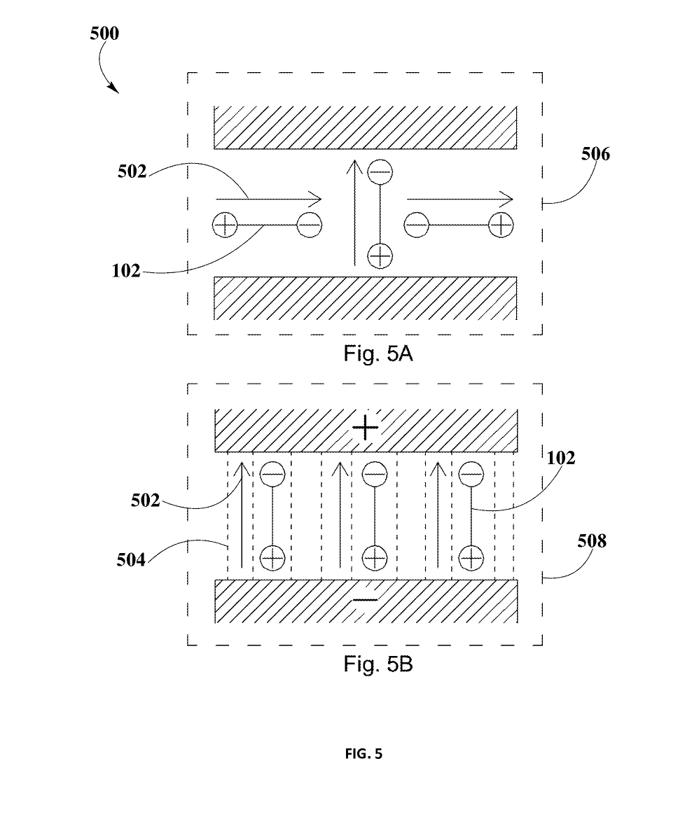

FIG. 5 depicts alignment process 500 employing electric fields to orient electric dipole moment (EDM 502) of PCCNs 102, depicted by electric field lines 504, which might be an example of application of orientational forces 404.

Molecules including more than one type of atoms generally may have the tendency to form bonds where electrons are not shared equally. In this kind of molecules a region with high electron density and a region with low electron density may be found.

PCCN 102 may include atoms of different electronegativity, which makes them polar molecules, as such they may include a positively charged region, which may include a lower concentration of atoms with low electronegativity, and a negatively charged region, which may have a higher concentration of atoms with high electronegativity. Accordingly, electron density may be higher in the space surrounding negatively charged region and lower in the spacer surrounding positively charged region, while PCCN 102 molecules remain neutral as a whole. Negatively charged region may include a negatively charged center, about which the negative charge is centered. Similarly, positively charged region may include a positive charged center, about which the positive charge is centered. If the locations of negatively charged center and positive charged center are not coincident, PCCN 102 molecules include an EDM 502. The magnitude of EDM 502 may be equal to the distance between positive charged center and negatively charged center multiplied by the magnitude of the charge at either charge region (positively charged region or negatively charged region). The direction of EDM 502 may depend on the structure and composition of PCCN 102, generally pointing towards negatively charged region.

In an embodiment, the photoactive material 506, including PCCN 102, may be exposed to an external electric field. The EDM 502 of PCCN 102 may interact with the external electric field, causing PCCN 102 to rotate in such a way that the energy of EDM 502 in external electric field may be minimized. In many cases, this means that EDM 502 of PCCN 102 may be parallel to the electric field lines 504 and form an oriented photoactive material 508 which may be employed as an oriented photocatalyst semiconductor surface that may allow to predict the polarity of the light, for a more efficient interaction with the oriented photoactive material 508 and increase the light harvesting efficiency. The EDM 502 of the nanocrystals is along the same axis, the rods are oriented in the same angle on the substrate, all in the same orientation.

According to another embodiment, alignment process 500 may be controlled using charged ligands. By controlling the charged ligands of the PCCN 102, specific orientations of the PCCN 102 may also be obtained.

In another embodiment, methods for the application of orientational forces 404 may include known in the art combing deposition technique, which may include a slowly wicking away solvent of the solution including the semiconductor nanocrystals 104 to be deposited, so that at the meniscus interface, semiconductor nanocrystals 104 experience a directional force along the direction of the wicking action.

In another embodiment, photoactive material may pass through a surface charge. Some of the faces of PCCN 102 may be ionic in nature and by having a charged substrate it may be possible to predefine which face or faces of PCCN 102 interact or are attached to the substrate during deposition. Cationic faces may be attracted to negatively charged substrates and anionic faces may be attracted towards positively charged substrates. For example, in PCCN 102 including Cd²⁺ or Zn²⁺, are generally cationic in nature and a negatively-charged substrate may preferentially attract these crystal faces, resulting in some degree of orientation of PCCN 102.

In yet another embodiment, photoactive material 506 may be oriented employing a Langmuir Blodgett film, which may be formed by employing Langmuir Blodgett method, resulting in the alignment of a thin film monolayer of PCCN 102 along 2 axes (1D or 2D orientation) to form oriented photoactive material 508.

Employing the Langmuir Blodgett method a PCCN 102 monolayer may be formed on a water surface by compression and subsequently the PCCN 102 monolayer may be transferred onto a suitable substrate by a controlled removal of the water sub-phase.

In an embodiment, photoactive material 506 may be oriented by controlling the surface-ligands. By controlling the ligands on the surface of the PCCN 102 and ligands on the surface of the substrate, specific orientations of the PCCN 102 to the substrate may be obtained.

PCCN 102 may include one or more alignment ligands associated with the PCCN 102. The structurally ordering of the plurality of PCCN 102 may be achieved by the interaction of a first alignment ligand on a first PCCN 102 with a second alignment ligand on an adjacent PCCN 102. Generally the first and second alignment ligands may be complementary binding pairs. Optionally, both complements of the binding pair are provided on the same molecule (e.g., a multifunctional molecule). In some embodiments, a single chemical entity can be used as the first and second alignment ligands. Alternatively, the two halves of the complementary binding pair can be provided on different compositions, such that the first and second alignment ligands are differing molecules.

Interacting the first and second alignment ligands to achieve the selective orientation of the plurality of PCCN 102, can be performed, for example, by heating and cooling the plurality of PCCN 102. In embodiments in which the first and second alignment ligands further include a crosslinking or polymerizable element, interacting the alignment ligands may include the step of crosslinking or polymerizing the first and second alignment ligands, e.g., to form a matrix.

As a further embodiment of the methods of the present disclosure, the plurality of oriented PCCN 102 may be affixed to a substrate or surface. Optionally, the first and second alignment ligands may be removed after affixing the aligned PCCN 102, to produce a plurality of oriented PCCN 102 on a substrate.

After alignment process 500, oriented photoactive material 508 may be cut into films to be used as oriented photocatalyst semiconductor surfaces in energy conversion applications, including photocatalytic water splitting and carbon dioxide reduction.

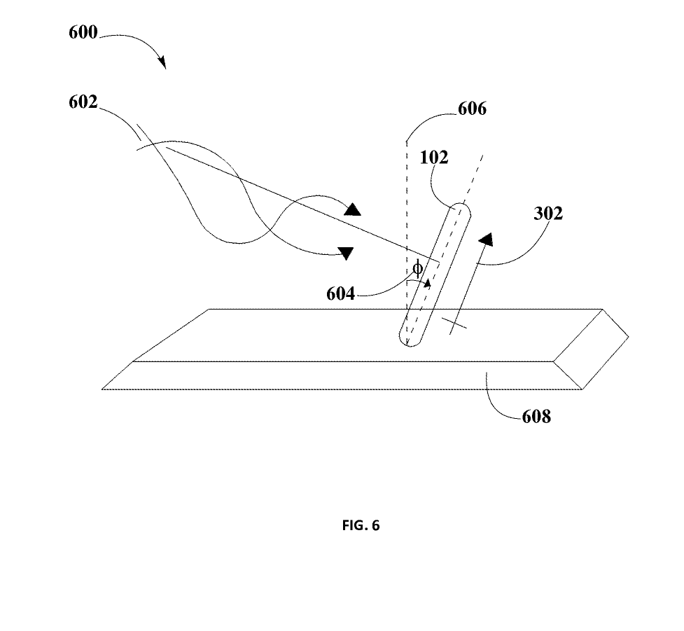

FIG. 6 depicts an embodiment of oriented PCCNs 600 in nanorod configuration 200 showing oriented TDM 302 receiving light 602. TDM 302 of oriented PCCN 600 may be oriented at an angle fi 604 from an axis 606 normal to the upper surface of substrate 608 onto which PCCN 102 has been deposited. Additionally, in order for light 602 to be absorbed by PCCN 102, light 602 may have a non-zero component of its electric field vector in line with TDM 302 of PCCN 102.

Oriented Photoactive Material

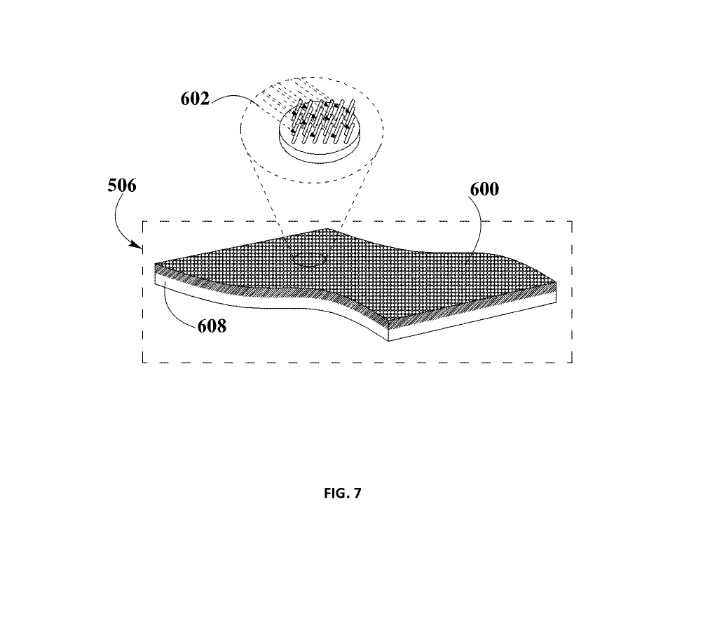

FIG. 7 illustrates an embodiment of oriented photoactive material 508, including oriented PCCNs 600 in nanorod configuration 200 upon substrate 608. Oriented PCCNs 600 in oriented photoactive material 508 may also exhibit carbon nanotube, nanosprings and nanowire configuration, among others.

In order to measure the performance of oriented photoactive material 508, devices such as transmission electron microscopy (TEM), and energy dispersive X-ray (EDX), among others, may be utilized. Performance of photoactive material may be related to light absorbance, charge carriers mobility and energy conversion efficiency. Performance of oriented photoactive material 508 may be related to light 602 absorbance, charge carriers mobility, and energy conversion efficiency.

Oriented photoactive material 508 may be employed in any of a number of devices and applications, including, but not limited to, various photovoltaic devices, optoelectronic devices (LEDs, lasers, optical amplifiers), light collectors, photodetectors and/or the like. Oriented photoactive material 508 may be also employed in energy conversion processes, such as, water splitting and carbon dioxide reduction, among others.

According to an embodiment, band gap of semiconductor nanocrystals 104, applied for carbon dioxide reduction process, should be large enough to drive carbon dioxide reduction process reactions but small enough to absorb a large fraction of light wavelengths. Band gap of PCCN 102 employed in the reduction of carbon dioxide should be at least 1.33 eV, which corresponds to absorption of solar photons of wavelengths below 930 nm. Considering the energy loss associated with entropy change (87 J/mol·K) and other losses involved in carbon dioxide reduction (forming methane and water vapor), band gaps between about 2 and about 2.4 eV may be preferred. Semiconductor nanocrystal 104 in oriented photoactive material 508 may be capped with a reduction photocatalyst as first inorganic capping agent 206 and an oxidative photocatalyst as second inorganic capping agent 208.

In other embodiment, for a water splitting process, photo-excited electrons in semiconductor nanocrystals 104 should have a reduction and oxidation potential greater than or equal to that necessary to drive the necessary reactions. Given overpotentials and loss of energy for transferring the charges to donor and acceptor states, the minimum energy may be closer to 2.1 eV. The wavelength of the irradiation light may be required to be about 1010 nm or less, in order to allow electrons to be excited and jump over band gap.

While various aspects and embodiments have been disclosed, other aspects and embodiments are contemplated. The various aspects and embodiments disclosed are for purposes of illustration and are not intended to be limiting, with the true scope and spirit being indicated by the following claims.

### Examples

Example#1 is an embodiment of method 100 to substitute an organic capping agent on semiconductor nanocrystals with an inorganic capping agent, which may be illustrated when CdSe is capped with a layer of organic capping agent and is soluble in non-polar or organic solvents such as hexane. Inorganic capping agent, Sn₂Se₆²⁻, is soluble in polar solvents such as DMSO. DMSO and hexane are appreciably immiscible, however. Therefore, a hexane solution of CdSe floats on a DMSO solution of Sn₂Se₆²⁻. After combining the two solutions (for about 10 minutes), the color of the hexane solution fades Within a short time, due to the presence of CdSe. At the same time, the DMSO layer becomes colored as the organic capping agents are displaced by the inorganic capping agents. The resulting surface-charged semiconductor nanocrystals are then soluble in a polar DMSO solution. The uncharged organic capping agent is preferably soluble in the non-polar solvent and may be thereby physically separated, from the semiconductor nanocrystal, using a separation funnel. In this manner, organic capping agents from the organic capped semiconductor nanocrystals are removed. CdSe and Sn₂Se₆²⁻ may be obtained from Sigma-Aldrich.

Example #2 is an embodiment of oriented photoactive material 508, which may be applied on a system for reducing carbon dioxide into methane. The carbon dioxide reduction system may operate in conjunction with a combustion system that produces carbon dioxide as a byproduct. This system may be employed to take advantage of carbon dioxide produced by one or more boilers during a manufacturing process. A boiler may be connected to a reaction vessel by inlet line to allow a continuous flow of carbon dioxide gas. Subsequently, carbon dioxide may pass through oriented photoactive material 508. Similarly, hydrogen gas may also be injected into the reaction vessel via inlet line. Optionally, a heater (not shown) may be employed to increase the temperature in the reaction vessel.

The produced methane molecule and water vapor may exit the reaction vessel through an outlet line and enter a collector, where a methane-permeable membrane and a water vapor permeable membrane may collect the methane molecules and water vapor, respectively. In one embodiment, the membranes may be a polymide resin membrane and a polydimethylsiloxane membrane, respectively. The collected methane molecules may be subsequently stored in any suitable storage medium, or it may be directly used as fuel by the boiler. The collected water vapor may be transferred to water condenser through outlet line to obtain liquid water. Valves, pumps or monitoring devices may be added in order to measure and regulate pressure and/or flow rate. The flow rate of carbon dioxide and hydrogen gas into the reaction vessel may be adjusted depending on reaction time between carbon dioxide, hydrogen gas, and oriented photoactive material 508. Optionally, a gas sensor device (not shown) may be attached to collector to identify any methane molecule leakage. Liquid water may be employed for different purposes in the manufacturing process.

Example #3 is an embodiment of oriented photoactive material 508, which may be applied on a system for water splitting where a continuous flow of water as gas or liquid may enter a reaction vessel through a nozzle. Subsequently, the water may pass through a region including oriented photoactive material 508 and may exit through a filter. The water coming through the nozzle may also include hydrogen gas, oxygen gas, and other gases such as an inert gas or air. According to an embodiment, the water entering the reaction vessel may include recirculated gas removed from the reaction vessel and residual water which did not react in the reaction vessel along with hydrogen gas and oxygen gas, as well as any other gas in the water splitting system. Preferably, a heater is connected to the reaction vessel to produce heat, so that water may boil, facilitating the extraction of hydrogen gas and oxygen gas through the filter. The heater may be powered by different energy supplying devices. Preferably, the heater may be powered by renewable energy supplying devices, such as photovoltaic cells, or by energy stored employing the system and method from the present disclosure. Materials for the walls of reaction vessel may be selected based on the reaction temperature.

The filter may collect impurities from water and may allow the exhaust of water from reaction vessel, including hydrogen gas, oxygen gas and water, which may flow through an exhaust tube.

After passing through the reaction vessel, water, hydrogen gas, and oxygen gas may be transferred through exhaust tube to a collector which may include a reservoir connected to a hydrogen permeable membrane (e.g. silica membrane) and an oxygen permeable membrane (e.g. silanized alumina membrane) for collecting hydrogen gas and oxygen gas to be stored in tanks or any other suitable storage equipment. A collector may also be connected to a recirculation tube which may transport the remaining exhaust gas back to a nozzle to supply additional water to reaction vessel. Additionally, the remaining exhaust gas may be used to heat water entering to the vessel. The flow of hydrogen gas, oxygen gas and water in the water splitting system may be controlled by one or more pumps, valves, or other flow regulators.

It should be understood that the present disclosure is not limited in its application to the details of construction and arrangements of the components set forth here. The present disclosure is capable of other embodiments and of being practiced or carried out in various ways. Variations and modifications of the foregoing are within the scope of the present disclosure. It also being understood that the invention disclosed and defined here extends to all alternative combinations of two or more of the individual features mentioned or evident from the text and/or drawings. All of these different combinations constitute various alternative aspects of the present invention. The embodiments described here explain the best modes known for practicing the invention and will enable others skilled in the art to utilize the invention.

Thus the scope of the invention should be determined by the appended claims and their legal equivalents, and not by the examples given.

The embodiments described above are intended to be exemplary. One skilled in the art recognizes that numerous alternative components and embodiments that may be substituted for the particular examples described herein and still fall within the scope of the invention.

What's claimed is:

1. A method for forming an oriented photoactive material comprising:
growing semiconductor nanocrystals;
capping the semiconductor nanocrystals with an inorganic capping agent in a polar solvent to form photocatalytic capped colloidal nanocrystals;
depositing the photocatalytic capped colloidal nanocrystals onto a substrate;
orienting the photocatalytic capped colloidal nanocrystals; and
thermally treating the oriented photocatalytic capped colloidal nanocrystals.

2. The method of claim 1, wherein orienting the photocatalytic capped colloidal nanocrystals is performed while depositing the photocatalytic capped colloidal nanocrystals onto the substrate.

3. The method of claim 1, wherein orienting the photocatalytic capped colloidal nanocrystals is performed after depositing the photocatalytic capped colloidal nanocrystals onto the substrate.

4. The method of claim 1, wherein orienting the photocatalytic capped colloidal nanocrystals is performed by applying an electric field, and the direction of the electric field is substantially parallel with a desired electric dipole moment of the photocatalytic capped colloidal nanocrystals.

5. The method of claim 4, wherein the photocatalytic capped colloidal nanocrystals include charged ligands that assist in controlling the orientation of the photocatalytic capped colloidal nanocrystals.

6. The method of claim 1, wherein orienting the photocatalytic capped colloidal nanocrystals comprises wicking away solvent of a solution that includes the photocatalytic capped colloidal nanocrystals before depositing the photocatalytic capped colloidal nanocrystals onto the substrate.

7. The method of claim 1, wherein growing semiconductor nanocrystals comprises growing semiconductor nanocrystals according to template-driven seeded growth.

8. The method of claim 1, wherein orienting the photocatalytic capped colloidal nanocrystals is performed by employing a Langmuir Blodgett method to form a Langmuir Blodgett film.

9. The method of claim 1, wherein the photocatalytic capped colloidal nanocrystals comprises one compound selected from the group consisting of ZnS.TiO₂, TiO₂.CuO, ZnS.RuOₓ, ZnS.ReOₓ, Au.AsS₃, Au.Sn₂S₆, Au.SnS₄, Au.Sn₂Se₆, Au.In₂Se₄, Bi₂S₃.Sb₂Te₅, Bi₂S₃.Sb₂Te₇, Bi₂Se₃.Sb₂Te₅, Bi₂Se₃.Sb₂Te₇, CdSe.Sn₂S₆, CdSe.Sn₂Te₆, CdSe.In₂Se₄, CdSe.Ge₂S₆, CdSe.Ge₂Se₃, CdSe.HgSe₂, CdSe.ZnTe, CdSe.Sb₂S₃, CdSe.SbSe₄, CdSe.Sb₂Te₇, CdSe.In₂Te₃, CdTe.Sn₂S₆, CdTe.Sn₂Te₆, CdTe.In₂Se₄, Au/PbS.Sn₂S₆, Au/PbSe.Sn₂S₆, Au/PbTe.Sn₂S₆, Au/CdS.Sn₂S₆, Au/CdSe.Sn₂S₆, Au/CdTe.Sn₂S₆, FePt/PbS.Sn₂S₆, FePt/PbSe.Sn₂S₆, FePt/PbTe.Sn₂S₆, FePt/CdS.Sn₂S₆, FePt/CdSe.Sn₂S₆, FePt/CdTe.Sn₂S₆, Au/PbS.SnS₄, Au/PbSe.SnS₄, Au/PbTe.SnS₄, Au/CdS.SnS₄, Au/CdSe.SnS₄, Au/CdTe.SnS₄, FePt/PbS.SnS₄FePt/PbSe.SnS₄, FePt/PbTe.SnS₄, FePt/CdS.SnS₄, FePt/CdSe.SnS₄, FePt/CdTe.SnS₄, Au/PbS.In₂Se₄Au/PbSe.In₂Se₄, Au/PbTe.In₂Se₄, Au/CdS.In₂Se₄, Au/CdSe.In₂Se₄, Au/CdTe.In₂Se₄, FePt/PbS.In₂Se₄FePt/PbSe.In₂Se₄, FePt/PbTe.In₂Se₄, FePt/CdS.In₂Se₄, FePt/CdSe.In₂Se₄, FePt/CdTe.In₂Se₄, CdSe/CdS.Sn₂S₆, CdSe/CdS.SnS₄, CdSe/ZnS.SnS₄, CdSe/CdS.Ge₂S₆, CdSe/CdS.In₂Se₄, CdSe/ZnS.In₂Se₄, Cu.In₂Se₄, Cu₂Se.Sn₂S₆, Pd.AsS₃, PbS.SnS₄, PbS.Sn₂S₆, PbS.Sn₂Se₆, PbS.In₂Se₄, PbS.Sn₂Te₆, PbS.AsS₃, ZnSe.Sn₂S₆, ZnSe.SnS₄, ZnS.Sn₂S₆, and ZnS.SnS₄.

10. The method of claim 1, wherein depositing the photocatalytic capped colloidal nanocrystals onto a substrate comprises spraying deposition.

11. The method of claim 1, wherein thermally treating the oriented photocatalytic capped colloidal nanocrystals comprises employing a convection heater heated to a temperature between 200 and 350 degrees.

12. The method of claim 1, further comprising, cutting the oriented photocatalytic capped colloidal nanocrystals into films.

13. The method of claim 1, wherein growing semiconductor nanocrystals by employing the template-driven seeded growth method comprises:
depositing a seed crystal on a substrate; and
growing the semiconductor nanocrystal from the seed crystal using molecular beam epitaxy or chemical beam epitaxy so that the semiconductor nanocrystal grows according to the seed crystal's structure.

14. The method of claim 1, wherein capping the semiconductor nanocrystals with an inorganic capping agent in the polar solvent to form the photocatalytic capped colloidal nanocrystals comprises:
reacting semiconductor nanocrystals precursors in the presence of an organic capping agent to form organic capped semiconductor nanocrystals;
reacting the organic capped semiconductor nanocrystals with an inorganic capping agent;
adding immiscible solvents causing the dissolution of the organic capping agents and the inorganic capping agents so that organic caps on the semiconductor nanocrystals are replaced by inorganic caps to form inorganic capped semiconductor nanocrystals; and
performing an isolation procedure to purify the inorganic capped semiconductor nanocrystals and remove the organic capping agent.

15. The method of claim 14, wherein the semiconductor nanocrystal precursors includes at least one from the group consisting of Ag, Au, Ru, Rh, Pt, Pd, Os, Ir, Ni, Cu, CdS, Pt-tipped, TiO₂, Mn/ZnO, ZnO, CdSe, SiO₂, ZrO₂, SnO₂, WO₃, MoO₃, CeO₂, ZnS, WS₂, MoS₂, SiC, GaP, Cu—Au, Ag, and mixtures thereof; Cu/TiO2, Ag/TiO₂, Cu—Fe/TiO₂—SiO₂ and dye-sensitized Cu—Fe/P25 coated optical fibers, AlN, AlP, AlAs, Bi, Bi₂S₃, Bi₂Se₃, Bi₂Te₃, CdS, CdSe, CdTe, Co, CoPt, CoPt₃, Cu₂S, Cu₂Se, CuInSe₂, CuIn₍₁₋ₓ₎Gaₓ(S,Se)₂, Cu₂ZnSn(S,Se)₄, Fe, FeO, Fe₂O₃, Fe₃O₄, FePt, GaN, GaP, GaAs, GaSb, GaSe, Ge, HgS, HgSe, HgTe, InN, InP, InSb, InAs, Ni, PbS, PbSe, PbTe, Si, Sn, ZnSe, ZnTe.

16. A photoactive material comprising:
a substrate; and
homogenously oriented photocatalytic capped colloidal nanocrystals deposited on the substrate, wherein the photocatalytic capped colloidal nanocrystals are oriented by applying an orientational force to the photocatalytic capped colloidal nanocrystals, and the orientation depends on a desired wavelength of visible or infrared light to be absorbed by the photocatalytic capped colloidal nanocrystals.

17. The photoactive material of claim 16, wherein each photocatalytic capped colloidal nanocrystal comprises:
a first semiconductor nanocrystal grown using template-driven seeded growth so that the first semiconductor nanocrystal is aligned; and
a first inorganic capping agent that caps the first semiconductor nanocrystal and acts as a photocatalyst to facilitate a photocatalytic reaction on a surface of the first semiconductor nanocrystal.

18. The photoactive material of claim 17, wherein the photocatalytic capped colloidal nanocrystals comprise one morphology from the group consisting of a core/shell configuration, a nanowire configuration, or a nanospring configuration.

19. The photoactive material of claim 17, wherein each photocatalytic capped colloidal nanocrystal comprises:
a second semiconductor nanocrystal grown using template-driven seeded growth so that the second semiconductor nanocrystal is aligned; and
a second inorganic capping agent that caps the second semiconductor nanocrystal and acts as a photocatalyst to facilitate a photocatalytic reaction on a surface of the second semiconductor nanocrystal.

20. The photoactive material of claim 16, wherein the photocatalytic capped colloidal nanocrystals comprise one morphology from the group consisting of a nanodendritic configuration, a tetrapod configuration, or a nanotube configuration.

21. The photoactive material of claim 16, wherein the photocatalytic capped colloidal nanocrystals comprise one compound selected from the group consisting of ZnS.TiO₂, TiO₂.CuO, ZnS.RuOₓ, ZnS.ReOₓ, Au.AsS₃, Au.Sn₂S₆, Au.SnS₄, Au.Sn₂Se₆, Au.In₂Se₄, Bi₂S₃.Sb₂Te₅, Bi₂S₃.Sb₂Te₇, Bi₂Se₃.Sb₂Te₅, Bi₂Se₃.Sb₂Te₇, CdSe.Sn₂S₆, CdSe.Sn₂Te₆, CdSe.In₂Se₄, CdSe.Ge₂S₆, CdSe.Ge₂Se₃, CdSe.HgSe₂, CdSe.ZnTe, CdSe.Sb₂S₃, CdSe.SbSe₄, CdSe.Sb₂Te₇, CdSe.In₂Te₃, CdTe.Sn₂S₆, CdTe.Sn₂Te₆, CdTe.In₂Se₄, Au/PbS.Sn₂S₆, Au/PbSe.Sn₂S₆, Au/PbTe.Sn₂S₆, Au/CdS.Sn₂S₆, Au/CdSe.Sn₂S₆, Au/CdTe.Sn₂S₆, FePt/PbS.Sn₂S₆, FePt/PbSe.Sn₂S₆, FePt/PbTe.Sn₂S₆, FePt/CdS.Sn₂S₆, FePt/CdSe.Sn₂S₆, FePt/CdTe.Sn₂S₆, Au/PbS.SnS₄, Au/PbSe.SnS₄, Au/PbTe.SnS₄, Au/CdS.SnS₄, Au/CdSe.SnS₄, Au/CdTe.SnS₄, FePt/PbS.SnS₄FePt/PbSe.SnS₄, FePt/PbTe.SnS₄, FePt/CdS.SnS₄, FePt/CdSe.SnS₄, FePt/CdTe.SnS₄, Au/PbS.In₂Se₄Au/PbSe.In₂Se₄, Au/PbTe.In₂Se₄, Au/CdS.In₂Se₄, Au/CdSe.In₂Se₄, Au/CdTe.In₂Se₄, FePt/PbS.In₂Se₄FePt/PbSe.In₂Se₄, FePt/PbTe.In₂Se₄, FePt/CdS.In₂Se₄, FePt/CdSe.In₂Se₄, FePt/CdTe.In₂Se₄, CdSe/CdS.Sn₂S₆, CdSe/CdS.SnS₄, CdSe/ZnS.SnS₄, CdSe/CdS.Ge₂S₆, CdSe/CdS.In₂Se₄, CdSe/ZnS.In₂Se₄, Cu.In₂Se₄, Cu₂Se.Sn₂S₆, Pd.AsS₃, PbS.SnS₄, PbS.Sn₂S₆, PbS.Sn₂Se₆, PbS.In₂Se₄, PbS.Sn₂Te₆, PbS.AsS₃, ZnSe.Sn₂S₆, ZnSe.SnS₄, ZnS.Sn₂S₆, and ZnS.SnS₄.

22. The photoactive material of claim 16, wherein the substrate is optically transparent.

23. The photoactive material of claim 16, wherein the substrate is a porous substrate, and the porous substrate exhibits a pore size sufficient for a gas to pass through at a constant flow rate.

24. The photoactive material of claim 16, wherein the substrate is parabolic.

25. The photoactive material of claim 16, wherein the substrate is planar.

26. The photoactive material of claim 16, wherein the substrate is charged so that a designated face of the photocatalytic capped colloidal nanocrystals attaches to the substrate during deposition.

27. The photoactive material of claim 16, wherein the photocatalytic capped colloidal nanocrystals each include a first alignment ligand and a second alignment ligand, wherein the first and second alignment ligands are complementary binding pairs.

28. The photoactive material of claim 16, wherein the orientational force is an electric field applied to the photocatalytic capped colloidal nanocrystals to orient the electric dipole moment of the photocatalytic capped colloidal nanocrystals.
